(19) United States
(12) Patent Application Publication
(10) Pub. No.: US 2012/0113352 A1
(43) Pub. Date: May 10, 2012

(54) Liquid Crystal Display Apparatus and a Frame Assembly Thereof

(75) Inventors: Kyu-Han Bae, Yongin-City (KR); Jeung-Soo Kim, Yongin-City (KR)

(73) Assignee: SAMSUNG MOBILE DISPLAY CO., LTD., Yongin-City (KR)

(21) Appl. No.: 13/241,544

(22) Filed: Sep. 23, 2011

(30) Foreign Application Priority Data
Nov. 9, 2010 (KR) 10-2010-0110997

(51) Int. Cl. G02F 1/1333

(52) U.S. Cl. 349/58

(57) ABSTRACT

A liquid crystal display (LCD) apparatus that is stable and has reduced assembling dispersion between a mold frame and a bezel. The liquid crystal display apparatus includes: an LCD panel; a backlight unit disposed at the back of the LCD panel; a mold frame having a storage space for storing the LCD panel and the backlight unit, and having an external surface on which a plurality of protruding units are formed; and a bezel for supporting and fixing the mold frame by contacting the plurality of protruding units and a lower outer surface of the mold frame.

### CLAIM OF PRIORITY

This application makes reference to, incorporates the same herein, and claims all benefits accruing under 35 U.S.C. §119 from an application earlier filed in the Korean Intellectual Property Office on 9 Nov. 2010, and there duly assigned Serial No. 10-2010-0110997 by that Office.

### BACKGROUND OF THE INVENTION

1. Field of the Invention

Embodiments of the present invention relate to a liquid crystal display apparatus and a frame assembly thereof.

2. Description of the Related Art

According to the development of semiconductor industries, products that are small and slim and have an improved performance are being produced.

A cathode ray tube (CRT) having a good performance and a reasonable price has been mostly used in the past, but is not small or portable. Recently, a liquid crystal display apparatus having a lower price than a CRT, a small size, a light weight, a thin thickness, and low power consumption is used as a replacement for the CRT.

Generally, a liquid crystal having intermediate characteristics of liquid and solid in the liquid crystal display apparatus is provided to a display device by using an electric property wherein an arrangement of liquid crystal molecules change according to an external electric field, and an optical property, such as double refraction, optical rotation, and light scattering characteristics of a liquid crystal cell.

In order to satisfy a small form factor of the liquid crystal display apparatus, components, such as a backlight, a connector, and a printed circuit board (PCB), of the liquid crystal display apparatus, or a combined structure of the components are continuously studied.

The liquid crystal display apparatus largely includes a liquid crystal display panel as a display screen when an image signal is applied, a backlight unit for irradiating a light to the liquid crystal display panel, a frame for storing the liquid crystal display panel and the backlight unit, and a bezel for fixing the frame.

When a tolerance is generated between the frame and the bezel while assembling the frame and the bezel, the frame may lean toward a certain direction in the bezel.

### SUMMARY OF THE INVENTION

Embodiments of the present invention provide a liquid crystal display apparatus having an excellent assemblage by reducing assembling dispersion of a mold frame and a bezel.

According to an aspect of the present invention, there is provided a liquid crystal display (LCD) apparatus including: an LCD panel; a backlight unit disposed at the back of the LCD panel; a mold frame having a storage space for storing the LCD panel and the backlight unit, and having an external surface on which a plurality of protruding units are formed; and a bezel for supporting and fixing the mold frame by contacting the plurality of protruding unit and a lower outer surface of the mold frame.

The plurality of the protruding unit may each point-contact an internal surface of the bezel.

A cross-sectional area of a side cross section of each of the plurality of protruding units may decrease from a contacting point with an internal surface of the bezel toward a lower surface of the bezel.

A pointed portion of each of the plurality of protruding units may have a horn shape pointing toward the internal surface of the bezel.

The pointed portion of each of the plurality of protruding units may have a polypyramid shape pointing toward the internal surface of the bezel.

The pointed portion of each of the plurality of protruding units may have a cone shape pointing toward the internal surface of the bezel.

The plurality of protruding units may have point-symmetrically formed with respect to a center of a storage surface of the mold frame.

The mold frame may have a rectangular shape with an opened top.

The plurality of protruding units may be formed along side portions of the mold frame, which extend parallel to each other.

The mold frame may have a rectangular shape comprising first and second long side portions extending in parallel to each other and first and second short side portions respectively extending perpendicular to the first and second long side portions, and the plurality of protruding units may be formed along the first and second long side portions of the mold frame.

The plurality of protruding units and the mold frame may be an injection molded product formed integrally.

The LCD apparatus may further include an adhesive disposed between the lower outer surface of the mold frame and an inner lower surface of the bezel.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is an exploded perspective view schematically illustrating a liquid crystal display apparatus and a frame assembly thereof according to an embodiment of the present invention;

FIG. 2 is a plan view schematically illustrating the liquid crystal display apparatus of FIG. 1;

FIG. 3 is a cross-sectional view taken along a line III-III of FIG. 1;

FIG. 4 is a magnified perspective view of a protruding unit of FIG. 1, according to an embodiment of the present invention;

FIGS. 5 through 7 are perspective views of the protruding unit of FIG. 1, according to other embodiments of the present invention;

FIG. 8 is a lateral cross-sectional view partially illustrating a contacting state of a mold frame and a bezel, in a liquid crystal display apparatus according to another embodiment of the present invention; and

FIG. 9 is a perspective view of a protruding unit according to another embodiment of the present invention.

### DETAILED DESCRIPTION OF THE INVENTION

Hereinafter, embodiments of the present invention will be described more fully with reference to the accompanying drawings, in which exemplary embodiments of the invention are shown.

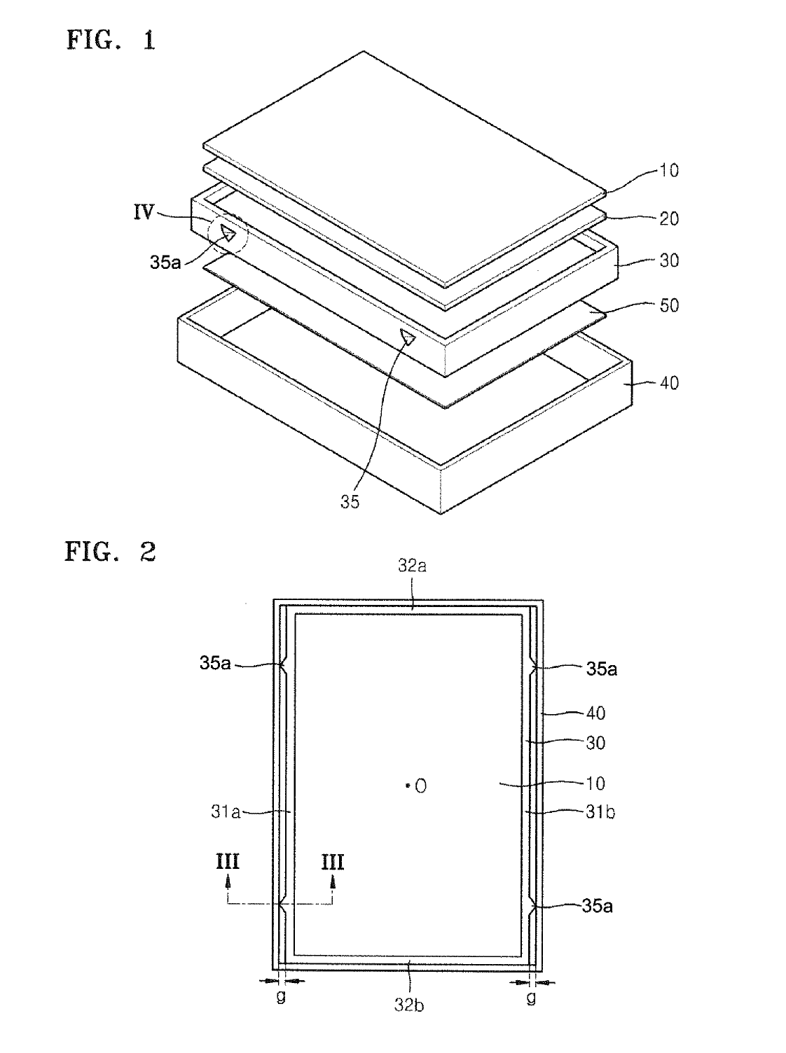

FIG. 1 is an exploded perspective view schematically illustrating a liquid crystal display (LCD) apparatus and a frame assembly thereof according to an embodiment of the present invention, and FIG. 2 is a plan view schematically illustrating the LCD apparatus of FIG. 1.

Referring to FIGS. 1 and 2, the LCD apparatus according to the current embodiment of the present invention includes an LCD panel 10, a backlight unit 20, a mold frame 30 including a plurality of protruding units 35a, and a bezel (outer frame) 40.

The LCD panel 10 displays an image through a screen display region. The LCD panel 10 displays an image by penetrating through or blocking a light by using a liquid crystal in which a molecule arrangement changes according to an applied electric field or magnetic field.

The backlight unit 20 is disposed at the back of the LCD panel 10 and irradiates a light to the LCD panel 10. The backlight unit 20 includes an illuminator (not shown) that receives external charges and emits a light, a light guide plate (not shown) that receives the light from the illuminator and evenly irradiates the light to a pixel region of the LCD panel 10, and other various optical films (not shown).

The mold frame 30 has an opened top to provide a storage space for storing the LCD panel 10 and the backlight unit 20. The LCD panel 10 and the backlight unit 20 are physically supported and fixed by the mold frame 30, and thus are prevented from being damaged by external vibration or shock.

The bezel 40 physically supports the mold frame 30 by contacting an external surface and a lower outer surface of the mold frame 30. Here, an assembling dispersion, i.e., a gap “g” of about 0.05 mm, is formed between an internal surface of the bezel 40 and the external surface of the mold frame 30 according to a manufacturing process. The protruding unit 35a formed on the mold frame 30 protrudes in the gap “g”.

An adhesive 50 is disposed between the lower outer surface of the mold frame 30 and a inner lower surface of the bezel 40, thereby improving fixability of the mold frame 30. The adhesive 50 may be a double-sided adhesive tape or a curing resin.

The protruding unit 35a formed on the external surface of the mold frame 30 protrudes in the gap “g” between the mold frame 30 and the bezel 40 so as to decrease the assembling dispersion between the mold frame 30 and the bezel 40. The protruding unit 35a may be an injection molding product formed integrally with the mold frame 30.

The protruding unit 35a is point-symmetrically formed with respect to a cross section of the storage space formed in the mold frame 30, i.e., with respect to a center “◯” of a storage surface of the mold frame 30. Since the point-symmetrical protruding units 35 are disposed between the mold frame 30 and the bezel 40 and are balanced with each other, an assembly of the mold frame 30 and the bezel 40 is stably maintained even when there is external vibration or shock from a certain direction.

The mold frame 30 is firmly fixed inside the bezel 40 since not only the internal surface of the bezel 40 and the external surface of the mold frame 30 contact each other through the protruding unit 35a, but also the inner lower surface of the bezel 40 and a lower outer surface of the mold frame 30 contact each other through the adhesive 50. Accordingly, the mold frame 30 and the bezel 40 are not shaken or separated from each other even when there is external vibration or shock from any direction.

Referring to FIG. 2, the storage surface of the mold frame 30 may have substantially a rectangular shape including first and second long side portions 31a and 31b extending parallel to each other, and first and second short side portions 32a and 32b extending parallel to each other and perpendicular to the first and second long side portions 31a and 31b. Here, the protruding unit 35a may be formed on the external surface of the mold frame 30, which correspond to the first and second long side portions 31a and 31b, point-symmetrically to the center “◯” of the storage surface of the mold frame 30.

In FIGS. 1 and 2, the mold frame 30 has a rectangular shape having an opened top and enclosed bottom, but a shape of the mold frame 30 is not limited thereto. For example, the storage surface of the mold frame 30 may have a circular or oval cylindrical shape.

Also, the protruding unit 35a is formed only on the first and second long side portions 31a and 31b, but a location of the protruding unit 35a is not limited thereto. For example, when the protruding unit 35a is point-symmetrically formed with respect to the center “◯” of the storage surface of the mold frame 30, the protruding unit 35a may be formed on the first and second short side portions 32a and 32b, or on the first and second long side portions 31a and 31b and the first and second short side portions 32a and 32b. Alternatively, if the mold frame 30 has a cylindrical shape, the protruding units 35 maybe spaced apart from each other at regular intervals point-symmetrically.

According to the current embodiment, the protruding unit 35a and the mold frame 30 are manufactured integrally, but alternatively, the protruding unit 35a and the mold frame 30 may be separately manufactured and then the protruding unit 35a may be combined to the external surface of the mold frame 30 via adhesion or the like.

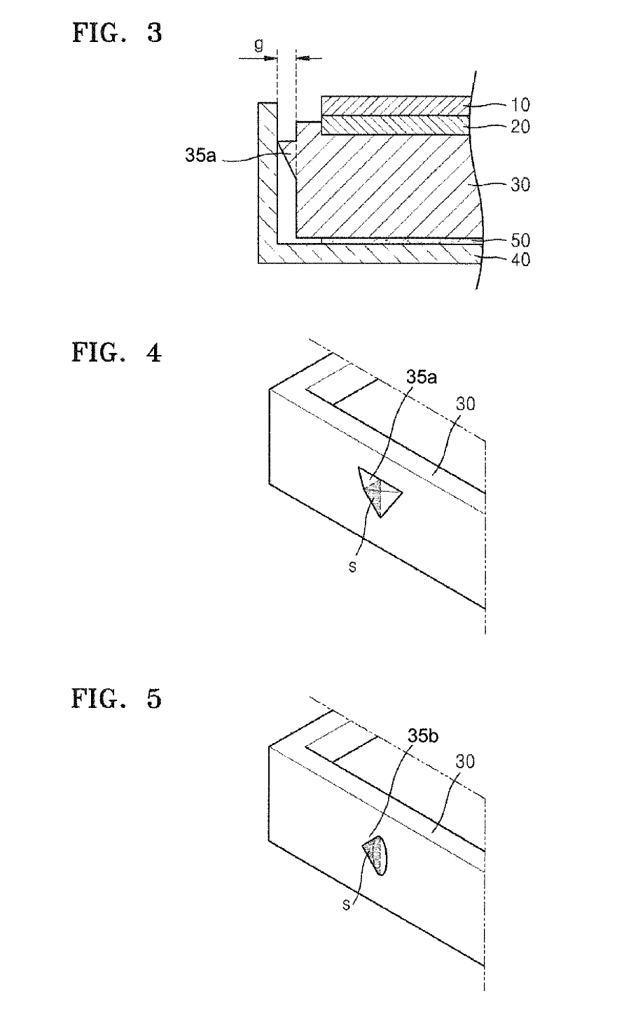

A contacting state between the protruding unit 35a formed on the mold frame 30 and the internal surface of the bezel 40, and a shape of the protruding unit 35a will now be described. FIG. 3 is a cross-sectional view taken along a line III-III of FIG. 2, and FIG. 4 is a magnified perspective view of the protruding unit 35a at area IV of FIG. 1, according to an embodiment of the present invention.

Referring to FIGS. 3 and 4, a cross-sectional area of a side cross section “S” of the protruding unit 35a decreases from a point contacting the internal surface of the bezel 40 downward toward the lower outer surface of the mold frame 30.

For example, the side cross section “S” of the protruding unit 35a may have a triangular shape. By manufacturing the protruding unit 35a in such a way that the cross-sectional area of the side cross section “S” is sloped downward, the mold frame 30 is easily inserted into the bezel 40. Since a side of the protruding unit 35a is sloped, the protruding unit 35a does not interrupt the inserting of the mold frame 30 into the bezel 40, and thus the mold frame 30 is easily inserted into the bezel 40. After the mold frame 30 is inserted, the mobility of the mold frame 30 is prevented by the protruding unit 35a.

Referring to FIGS. 3 and 4, the protruding unit 35a may point-contact the internal surface of the bezel 40. A pointed portion of the protruding unit 35a may have a triangular pyramid (tetrahedron) shape pointing toward the lower outer surface of the mold frame 30. In the current embodiment of the present invention, the mold frame 30 may be easily inserted into the bezel 40 since the cross-sectional area of the side cross section “S” of the protruding unit 35a decreases from the point contacting the internal surface of the bezel 40 toward the lower outer surface of the mold frame 30. Moreover, since the protruding unit 35a point-contacts the bezel 40, unnecessary friction between the protruding unit 35a and the bezel 40 may be avoided from the extended point where the protruding unit 35a contacts the bezel 40 to the point where the protruding unit 35a completely contacts the side surface of the mold frame 30. In other words, the protruding unit 35a and the bezel 40 contact each other to a degree only sufficient enough to prevent the mold frame 30 from moving.

If the protruding unit 35a had a square or circular pillar shape the protruding unit 35a would contact the bezel 40 from the moment the mold frame 30 is inserted into the bezel 40, and if a width of the protruding unit 35a is formed slightly larger than a width of the gap “g”, the mold frame 30 and the bezel 40 may not be assembled or the shape of the mold frame 30 or the bezel 40 may be partially misshaped if the mold frame 30 is forced into the bezel 40.

However, in the current embodiment, such phenomena do not occur since the cross-sectional area of the side cross section of the protruding unit 35a decreases toward the lower outer surface of the mold frame 30, and the protruding unit 35a and the bezel 40 point-contact each other.

FIG. 5 is a perspective view of a protruding unit 35b, according to another embodiment of the present invention. In the current embodiment, the protruding unit 35b may have the conical shape, and particularly the shape of an elliptical cone. Here, a center of a cone is moved upward toward the LCD panel 10, so that the side cross section “S” of the protruding unit 35b has a triangular shape like FIG. 4.

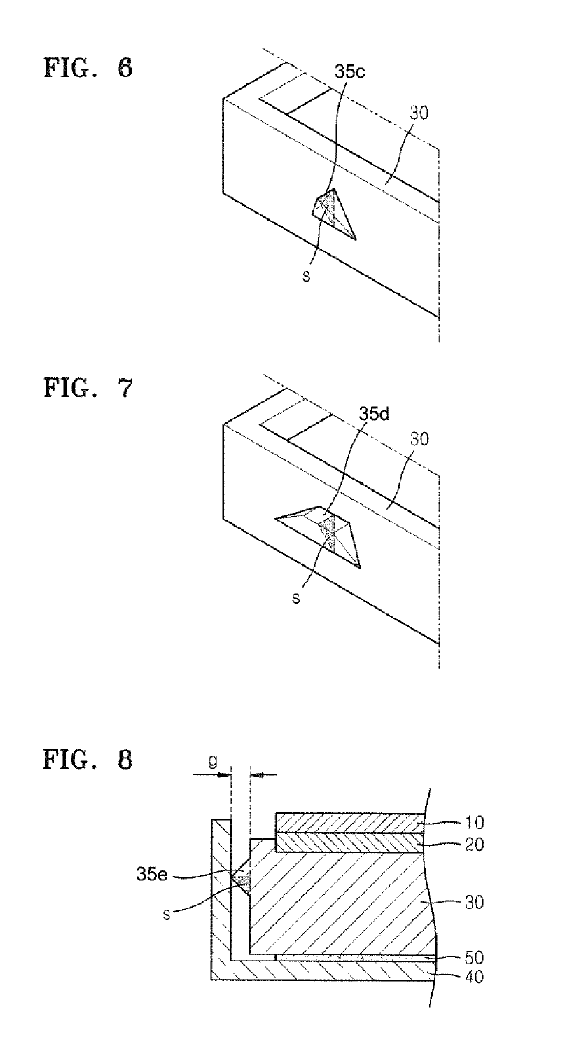

FIG. 6 is a perspective view of the protruding unit 35c, according to another embodiment of the present invention. In the current embodiment, the protruding unit 35c has a tetrahedron shape disposed in a different orientation from the protruding unit 35a of FIG. 4. In the current embodiment, one face of the protruding unit 35c decreases from a point contacting the internal surface of the bezel 40 downward toward the lower outer surface of the mold frame 30 forming a slope, whereas in the embodiment of FIG. 4, one edge of the protruding unit 35a extends from a point contacting the internal surface of the bezel 40 downward toward the lower outer surface of the mold frame 30 forming a slope. The side cross section “S” of the protruding unit 35c has a triangular shape like FIG. 4.

FIG. 7 is a perspective view of the protruding unit 35d, according to another embodiment of the present invention. Referring to FIG. 7, the side cross section “S” of the protruding unit 35d has a triangular shape like FIG. 6. However, the slope formed by one face of the protruding unit 35d, which decreases from a line contacting the internal surface of the bezel 40 downward toward the lower outer surface of the mold frame 30, has a trapezoidal shape. Here, even when the protruding unit 35d line-contacts the bezel 40, the mold frame 30 is easily inserted into the bezel 40 since the cross-sectional area of the one face of the protruding unit 35d decreases toward the lower outer surface of the mold frame 30.

FIG. 8 is a lateral cross-sectional view partially illustrating a cross section of a LCD apparatus according to another embodiment of the present invention. Like the LCD apparatus of FIGS. 1, 3 and 4, in the LCD apparatus according to the current embodiment of the present invention, the cross-sectional area of the side cross section “S” of the protruding unit 35e also decreases from the point contacting the internal surface of the bezel 40 toward the lower outer surface of the mold frame 30. However, an edge surface of the protruding unit 35d according to the current embodiment, which faces upward, is also sloped. That is, where the protruding unit 35a of FIG. 4 has a triangular pyramid shape, the protruding unit 35e of FIG. 8 has a rectangular pyramid shape, a vertex of each being in point-contact with the internal surface of the bezel 40.

Even if the side cross section of the surface of the protruding unit 35e, which faces a top of the bezel 40, is sloped, the surface does not affect the inserting of the mold frame 30 into the bezel 40. Accordingly, like the previous embodiments, the protruding unit 35e of the current embodiment enables the mold frame 30 to be easily assembled with the bezel 40.

In the current embodiment, the surface of the protruding unit 35e, which faces the top of the bezel 40, is sloped, but a shape of a top surface of the protruding unit 35e is not limited as long as the protruding unit 35e does not interrupt the mold frame 30 from being inserted into the bezel 40 since the protruding unit 35e does not protrude more than the point contacting the internal surface of the bezel 40.

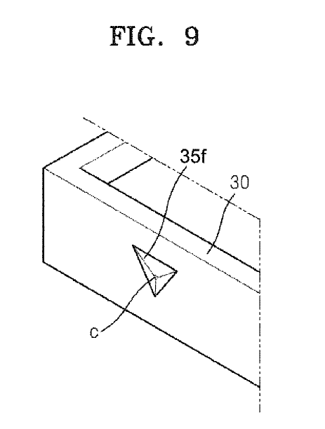

FIG. 9 is a perspective view of the protruding unit 35f according to another embodiment of the present invention. Here, a portion “c” of the protruding unit 35f, which contacts the bezel 40, may be formed via chamfering, i.e., cutting off an edge or corner of protruding unit 35f to form a bevel.

As described above, the assembling dispersion of the mold frame 30 and the bezel 40 is reduced and the mold frame 30 and the bezel 40 are stable against external vibration or shock, since the protruding unit 35 is formed on the side of the mold frame 30 and the mold frame 30 and the bezel 40 contact each other.

Also, the mold frame 30 and the bezel 40 maybe easily assembled since the cross-sectional area of the side cross section of the protruding unit 35 decreases from the point contacting the bezel 40 toward the lower outer surface of the mold frame 30.

According to the embodiments of the present invention, an LCD apparatus, which has excellent assemblage since assembling dispersion between a mold frame and a bezel is reduced by forming a protruding unit on a side of the mold frame, and is stable against vibration or shock in an up-and-down or top-and-bottom directions, may be provided.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A liquid crystal display (LCD) apparatus comprising:
an LCD panel;
a backlight unit disposed at the back of the LCD panel;
a mold frame having a storage space for storing the LCD panel and the backlight unit, and having an external surface on which a plurality of protruding units are formed; and
a bezel for supporting and fixing the mold frame by contacting the plurality of protruding units and a lower outer surface of the mold frame.

2. The LCD apparatus of claim 1, wherein the plurality of the protruding unit each point-contact an internal surface of the bezel.

3. The LCD apparatus of claim 1, wherein the cross-sectional area of the side cross section of each of the plurality of protruding units slopes from a contacting point with an internal surface of the bezel toward a lower outer surface of the mold frame.

4. The LCD apparatus of claim 3, wherein a pointed portion of each of the plurality of protruding units has a shape pointing toward the internal surface of the bezel.

5. The LCD apparatus of claim 4, wherein the pointed portion of each of the plurality of protruding units has a pyramidal shape pointing toward the internal surface of the bezel.

6. The LCD apparatus of claim 4, wherein the pointed portion of each of the plurality of protruding units has a conical shape pointing toward the internal surface of the bezel.

7. The LCD apparatus of claim 1, wherein the plurality of protruding units are point-symmetrically formed with respect to a center of a storage surface of the mold frame.

8. The LCD apparatus of claim 1, wherein the mold frame has a rectangular shape with an opened top.

9. The LCD apparatus of claim 8, wherein the plurality of protruding units are formed along side portions of the mold frame, which extend parallel to each other.

10. The LCD apparatus of claim 1, wherein the mold frame has a rectangular shape comprising first and second long side portions extending in parallel to each other and first and second short side portions respectively extending perpendicular to the first and second long side portions, and
the plurality of protruding units are formed along the first and second long side portions of the mold frame.

11. The LCD apparatus of claim 1, wherein the plurality of protruding units and the mold frame are an injection molded product formed integrally.

12. The LCD apparatus of claim 1, further comprising an adhesive disposed between the lower outer surface of the mold frame and an inner lower surface of the bezel.
